(19) United States
(12) Patent Application Publication
(10) Pub. No.: US 2007/0082687 A1
(43) Pub. Date: Apr. 12, 2007

(54) Station selecting transmitter

(75) Inventor: Matthew A. Jubelirer, Seattle, WA (US)

Correspondence Address: MICROSOFT CORPORATION;ATTN: PATENT GROUP DOCKETING DEPARTMENT, ONE MICROSOFT WAY, REDMOND, WA, 98052-6399, US

(73) Assignee: Microsoft Corporation, Redmond, WA (US)

(21) Appl. No.: 11/245,622

(22) Filed: Oct. 7, 2005

(51) Int. Cl. H04B 7/00; H04Q 7/20

(52) U.S. Cl. 455/515; 455/509; 455/513

(57) ABSTRACT

Transmitting a wireless signal from a transmitter to a receiver includes receiving an indication that a signal transmission is desired, in response to the indication, automatically searching an available frequency range for a station meeting an ambient signal strength criteria, and transmitting the wireless signal to the receiver at the station. Automatically searching the available frequency range may include determining ambient signal strength for each of a plurality of different stations to find a station having an ambient signal strength below a predetermined limit. The indication that a new station is to be selected may be user actuated or may be automatic. A transmitter may include a first input that receives an electronic audio signal, a second input that receives ambient signals at a range of frequencies used for transmitting by the transmitter, and a processor, coupled to at least the second input, that selects a station for the transmitter to transmit the electronic audio signal. The processor iteratively tests stations in a range of frequencies for the transmitter and selects a station having an ambient signal below a predetermined limit.

### BACKGROUND

Many portable media devices, such as MP3 players, use headphones, ear buds, or the like to provide an audio signal to a single listener. While this is fine in some cases, in others it is not. For example, a driver may not use a portable media device with headphones or ear buds while driving because it is not considered safe. In addition, there may be instances where it is desirable to provide the output of a portable media device to more than one user at the same time.

Manufacturers have provided different solutions to address this, including transmitters that receive input from a portable media player (e.g., via the headphone jack) and transmit a weak signal to a receiver in close proximity to the transmitter. In some instances, an FM transmitter and an FM receiver are used. The transmitter enables media stored on a portable media player to be played back on an available audio system such as a car or home stereo system using an available (unused) station frequency.

A difficulty with such transmitters is that they operate best when used at a frequency that does not otherwise contain any broadcast signals or other interference even though the operating frequency of the transmitters is usually part of the usable frequency of the receivers. For example, a transmitter used with a conventional FM receiver transmits in the available commercial FM broadcasting band. Some transmitters use a switch that allows the user to select from a few (e.g., four to six) preset frequencies for operation, hoping that at least one is available (i.e., otherwise unused). Other transmitters may use a manual scroll wheel that allows the users to scroll through the entire spectrum of available frequencies. Some transmitters are digital and contain an LCD display that allows the user to view the selected frequency.

All of the above-described transmitters require the user to use the receiver to first find an unused frequency band. If a frequency band is available, the user may then set the corresponding transmitter to that frequency. This process may be time consuming because it requires the user to adjust both the receiver and the transmitter and because there does not appear to be any automatic seek functionality for unused frequency bands on conventional receivers. Thus, the user is required to manually adjust the receiver frequency and “listen” for no signal. Understandably, this process sometimes ends with a frustrating sound quality experience for the user.

### SUMMARY

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

Transmitting a wireless signal from a transmitter to a receiver includes receiving an indication that a signal transmission is desired, in response to the indication, automatically searching an available frequency range for a station meeting an ambient signal strength criteria, and transmitting the wireless signal to the receiver at the station. Automatically searching the available frequency range may include determining ambient signal strength for each of a plurality of different stations to find a station having an ambient signal strength below a predetermined limit. The indication that a new station is to be selected may be user actuated or may be automatic.

A transmitter setting a station for transmitting a signal includes the transmitter selecting a station from a number of possible stations for transmission and the transmitter determining ambient signal strength at the station. If the ambient signal strength is below a predetermined limit, the station is chosen. If the ambient signal strength is not below the predetermined limit, the transmitter selects a different station and determines ambient signal strength at the different station. It is possible to iterate through all of the possible stations and, if no station is found, change the limit and iterate through all of the stations again.

A transmitter may include a first input that receives an electronic audio signal, a second input that receives ambient signals at a range of frequencies used for transmitting by the transmitter, and a processor, coupled to at least the second input, that selects a station for the transmitter to transmit the electronic audio signal. The processor iteratively tests stations in a range of frequencies for the transmitter and selects a station having an ambient signal below a predetermined limit. The transmitter may include a display and/or a user actuated button.

### DESCRIPTION OF THE DRAWINGS

FIG. 1 is a diagram that illustrates a source device, a transmitter, and a receiver according to an embodiment of the system described herein.

FIG. 2 is a diagram that illustrates a source device, a transmitter, and a receiver according to an alternative embodiment of the system described herein.

FIG. 3 is a diagram that illustrates a transmitter according to an embodiment of the system described herein.

FIG. 4 is a flow chart that illustrates operation of an embodiment of the system described herein.

FIG. 5 is a flow chart that illustrates monitoring signal quality according to an embodiment of the system described herein.

FIG. 6 is a diagram that illustrates a source device, a transmitter, and a receiver according to an alternative embodiment of the system described herein.

### DETAILED DESCRIPTION

Described herein are various technologies and techniques for facilitating communication between an audio signal source and a receiver. Various embodiments are described more fully below with reference to the accompanying drawings, which form a part hereof, and which show specific exemplary embodiments for practicing various embodiments. However, other embodiments may be implemented in many different forms and should not be construed as limited to the embodiments set forth herein; rather, these embodiments are provided so that this disclosure will be thorough and complete. Embodiments may be practiced as methods, systems or devices. Accordingly, embodiments may take the form of a hardware implementation, an entirely software implementation or an implementation combining software and hardware aspects. The following detailed description is, therefore, not to be taken in a limiting sense.

The logical operations of the various embodiments are implemented (1) as a sequence of computer implemented steps running on a computing system and/or (2) as interconnected machine modules within the computing system. The implementation is a matter of choice dependent on the performance requirements of the computing system implementing the embodiment. Accordingly, the logical operations making up the embodiments described herein are referred to alternatively as operations, steps or modules.

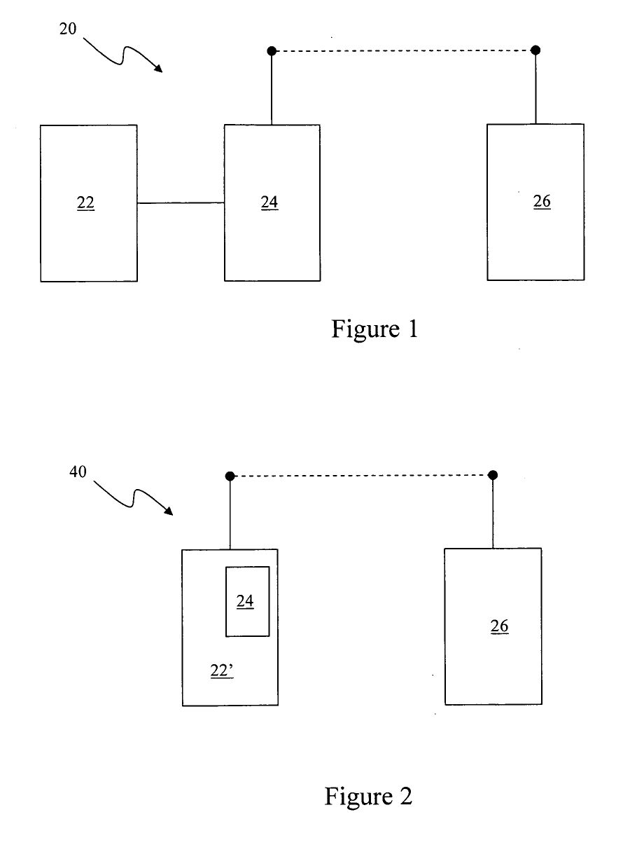

Referring to FIG. 1, a diagram 20 illustrates a source device 22, a transmitter 24 and a receiver 26. The source device 22 may be any type of device capable of producing an electronic signal representative of an audio signal (hereinafter “electronic audio signal”), such as an MP3 player, a CD player, or a tape player. The receiver 26 may be any type of device capable of receiving a wireless electronic audio signal and causing an audio signal to be reproduced for listening by a user (e.g., using one or more speakers). In an embodiment herein, the receiver 26 may be an FM radio receiver found in an automobile. However, other types of receivers may be used consistent with the discussion herein.

The transmitter 24 may be electronically coupled to the source device 22 and may receive the electronic audio signal from the source device 22 (e.g., via a headphone jack) and transmit a wireless signal that is received by the receiver 26. A wireless signal may be considered any signal that is transmitted from a source to a destination where at least part of the transmission path does not use wires or the like to propagate the signal. When the receiver 26 is an FM radio receiver, the transmitter 24 is an FM transmitter. Thus, an electronic audio signal is generated at the source device 22 (e.g., an MP3 player), provided to the transmitter 24, and transmitted from the transmitter 24 to the receiver 26 (e.g., an FM radio receiver) via a wireless FM signal. In some embodiments, the power of the wireless signal generated by the transmitter 24 is limited by law and/or regulation so that the signal generated by the transmitter 24 does not interfere with other legitimate signals (e.g., commercial broadcast signals). For example, if the receiver 26 is an FM radio receiver and the transmitter 24 transmits FM radio signals, then it may be desirable to restrict the transmission power of the transmitter 24 so as to minimize interference with commercial FM broadcast signals.

As described in more detail elsewhere herein, the transmitter 24 determines a frequency on which to transmit by sampling the available frequencies and selecting a station having an amount of signal energy from other sources less than a predetermined limit. The selected station is then used for transmitting the wireless signal from the transmitter 24 to the receiver 26. Note that although in some contexts the term “station” may refer to a frequency band in a radio frequency spectrum over which a commercial broadcast signal is provided, the term “station” may be understood herein to be broader and refer to any frequency or frequency band irrespective of whether there are any commercial broadcast signals on that band, irrespective of whether the frequencies of the frequency band is wider or narrower than a commercial broadcast frequency band and irrespective of and irrespective of whether or not the frequencies of the frequency band are contiguous.

Referring to FIG. 2, a diagram 40 illustrates an alternative embodiment where the transmitter 24 is integrated into a source device 22′. In the embodiment illustrated by the diagram 40, the source device 22′ and the transmitter 24 may be a single integrated unit that generates the electronic audio signal and transmits the wireless signal to the receiver 26.

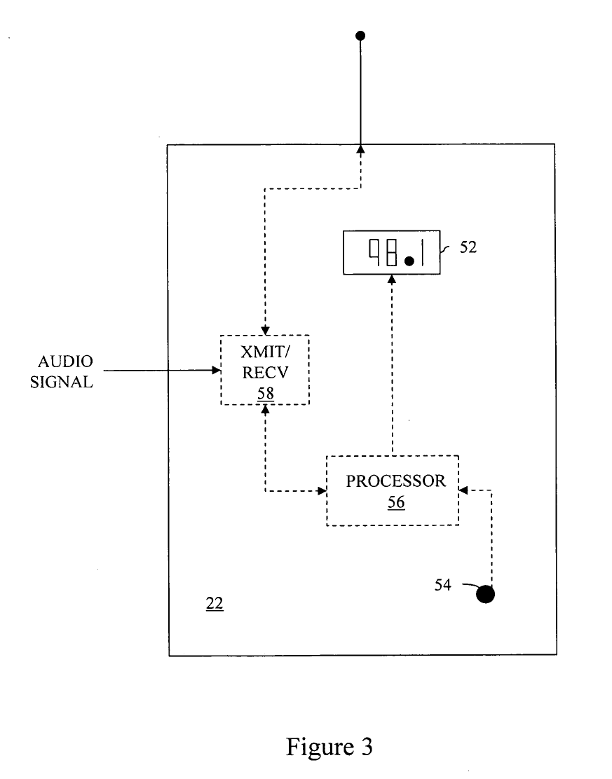

Referring to FIG. 3, the transmitter 24 is shown in more detail as including an optional display 52 and an optional user actuated button 54. As described in more detail elsewhere herein, the transmitter 24 may automatically select an appropriate station for transmission from the transmitter 24 to the receiver 26. The display 52 illustrates the selected station to the user. In some embodiments, the user may then manually tune in the receiver 26 to the station indicated by the display 52. In other embodiments, other mechanisms may be used to tune the receiver 26 to the appropriate station. Note that the display 52 could be any type of display capable of conveying station information to a user, including an LCD display.

The user actuated button 54 may be used to initiate selection of an appropriate station by the transmitter 24. Of course, any appropriate device allowing a user to provide input to the transmitter 24 may be used for the button 54. Thus, the term “button”, as used herein, should be understood to include any device capable of allowing a user to provide a signal indicating a desire to search for and select a new station. As described in more detail elsewhere herein, in some cases the transmitter 24 may automatically initiate a search and selection for an appropriate station without any input from the user. Thus, in some cases, the transmitter may initiate selection of an appropriate station either in response to the user actuating the button 54 and/or in response to other conditions, described elsewhere herein.

In some embodiments the transmitter 24 may also include a processor 56, which provides general purpose processing consistent with the discussion herein. The processor 56 may provide a signal to the display 52 to cause the display to show the selected station as discussed herein. The processor may also receive a signal from the user actuated button 54.

The transmitter 24 may also include transmit and receive components 58, which may be conventional off-the-shelf or other types of electronic audio components that receive the electronic audio signal from the source 22 and modulate the signal at the frequency of the wireless signal transmitted by the transmitter 24. The transmit and receive components 58 may also receive wireless signals and provide appropriate data indicative thereof (e.g., signal strength) to the processor 56. Thus, the transmit and receive components 58 may be coupled to, and exchange signals with, the processor 56 to provide the functionality described herein (i.e., to indicate to the processor 56 the strength of ambient signals at different stations and to modulate the electronic audio signal at a station frequency selected by the processor 56 to transmit the wireless signals described herein).

Implementation of the transmitter 24 may be straight-forward based on the description herein using conventional off-the-shelf or other types of hardware components for transmission, reception, signal analysis, processing, etc. For example, note that the transmitter 24 may use some or all of the transmission components thereof to also receive the ambient signal or may use a completely different set of components. The particular choice of components for the transmitter 24 is largely a matter of design choice dependent on the performance requirements of the system described herein and on a variety of other factors, including commercial factors such as manufacturing costs, reliability, mass production considerations, etc.

The operations described herein may be referred to variously as steps, operations, structural devices, acts or modules. However, it is noted that these operations, structural devices, acts and modules may be implemented in software, in firmware, in special purpose digital logic, a computer readable medium having computer executable instructions, and any combination thereof without deviating from the spirit and scope of the system described herein. Furthermore, it should be appreciated that while a particular order of operation is set forth with respect to the logical operations illustrated herein, other orders of operation are possible, unless indicated otherwise or apparent from the context.

The system described herein automatically selects a station (i.e, a frequency) for transmission according to specific criteria, such as the ambient signal strength at the station. Different embodiments may use various mechanisms or criteria to traverse through frequencies, sequentially, or randomly, or based on some more elaborate traversal rules. The first or nth station below a threshold having a lowest ambient signal strength may be selected for transmission. The discussion below is a detailed description of a particular implementation where it is understood that other implementations are contemplated.

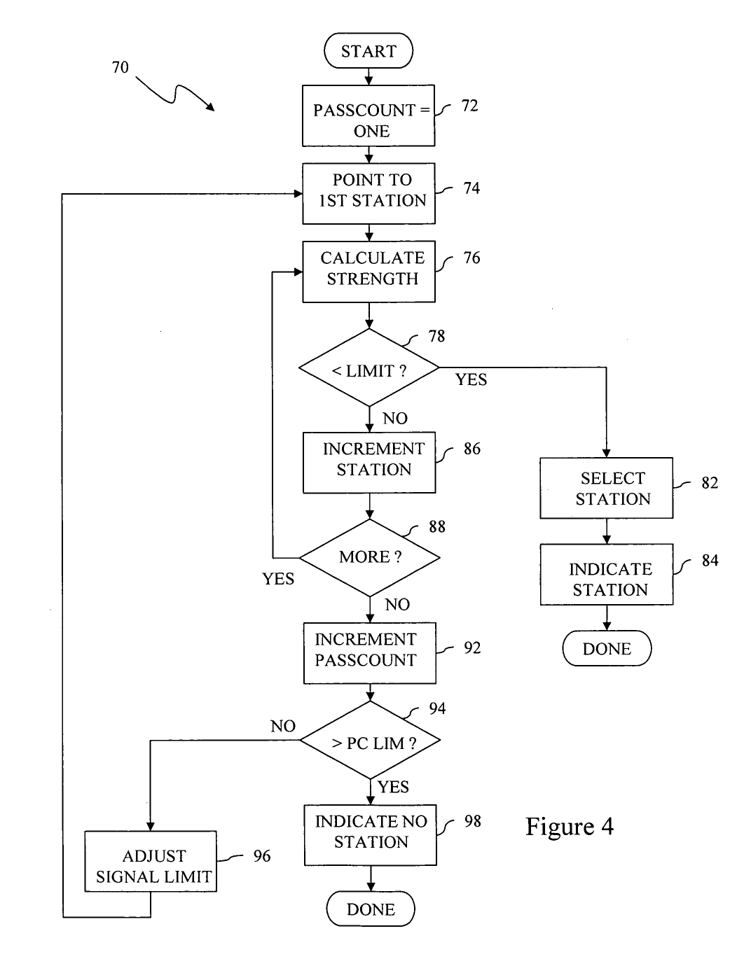

Referring to FIG. 4, a flowchart 70 illustrates steps performed in connection with searching for and selecting an appropriate station for transmitting from the transmitter 24 to the receiver 26. In an embodiment herein, the processing performed by the steps illustrated by the flow chart 70 use a processor coupled to appropriate components of the transmitter to allow reception of signals and actuation of components (e.g., the display 52) to provide the functionality described herein. However, as discussed elsewhere herein, other implementations are possible without departing from the spirit and scope of the system described herein.

Processing begins at a first step 72 where a pass count variable is initialized to one. Use of the pass count variable is described in more detail below. Following the step 72 is a step 74 where a station pointer is made to indicate an initial portion of the usable frequency spectrum of the transmitter 24. As described below, the station pointer may be used to iterate through the spectrum to find a suitable station. In an embodiment herein, the station pointer may be made to indicate the beginning of the spectrum at the step 74 where each iteration increases the frequency. However, the system described herein may be implemented in other ways having the station pointer initially indicate any portion of the spectrum where each iteration changes the frequency in an appropriate manner.

Following the step 74 is a step 76 where processing is provided to perform a signal strength determination of a received wireless signal (i.e., ambient signals) at the station pointer. The calculation performed at the step 76 may be any one of a number of appropriate signal strength determinations, including squaring the amplitude of the measured signal level, performing an RMS calculation, or any other appropriate calculation. In some instances, the signal strength may be a measure of signal energy, but in other cases it may not be. For example, the calculation performed at the step 76 may take into account both the energy of the signal and an average estimate of the signal peaks.

Following the step 76 is a test step 78 where it is determined if the signal strength calculated at the step 76 is less than a predetermined limit. The limit used at the step 78 may be any appropriate value that allows for selection of a station having an appropriately low ambient signal strength (e.g., one that does not cause too much undesirable interference to a listener). The limit used at the step 78 may be set by empirically determining a value therefor that provides desirable performance of the system. Also, as described below, the limit may be modified for subsequent iterations.

Note that criteria other than ambient signal strength may be used to automatically select a station for transmission, in which case the test at the step 78, and perhaps the determination at the step 76, may be different. In addition, it is possible for the criteria used at the step 78 to be the ambient signal strength combined with some other criteria. Thus, the system described herein contemplates station selection based on ambient signal strength, some other criteria, or a combination of ambient signal strength and some other criteria.

If it is determined at the test step 78 that the signal strength calculated at the step 76 is below the predetermined limit, then control transfers from the test step 78 to a step 82 where the station pointed to by the pointer is set for the transmitter 24 so that the transmitter 24 transmits the wireless signal at that frequency. Following the step 82 is a step 84 where the selected station is indicated to the user by, for example, numerically displaying the frequency of the station at the display 52 of the transmitter 24. In other embodiments (described below) where the transmitter 24 may automatically provide the value of the selected station to the receiver 26, the step 84 may include automatically setting the station at the receiver 26. Also, such embodiments may not use or need the display 52 at all and thus may not indicate any station to the user. Following the step 84, processing is complete.

Note that the processing described above tends to locate a first available station. If there is a reason to not always do this (e.g., to avoid collisions among multiple transmitters), then it is possible to add logic that randomly selects the nth available station. Such logic could a) choose a relative low random number (e.g., two through ten); b) set a counter to one; c) increment the counter each time an acceptable station is found; and d) perform the processing at the steps 82, 84 only when the counter equals the random number determined at a).

If it is determined at the test step 78 that the signal strength calculated at the step 76 is not less than the predetermined limit, then control transfers from the test step 78 to a step 86 to increment the pointer used to iterate through the stations of the available stations. In an embodiment herein, the pointer is initially set to the beginning of the frequency band of the transmitter 24 at the step 74 and incrementing the pointer at the step 86 involves increasing the pointer by an amount corresponding to a single station. However, in other embodiments, it may be possible to set the pointer to other initial values at the step 74 and/or have the increment step 86 appropriately modified the pointer. It is possible to have the step 86 randomly modify the pointer with the understanding that it may be less desirable in certain situations to have the pointer be equal to the same frequency more than once for a particular iteration. In other situations, this may be acceptable.

Following the step 86 is a test step 88 which determines if more stations in the frequency band of the transmitter 24 are available. If so, then control transfers from the test step 88 back to the step 76 to calculate the signal strength at the station corresponding to the new value of the pointer. Otherwise, if it is determined at the test step 88 that there are no more stations available (i.e., all have been tested already), then control passes from the test step 88 to a step 92 where the pass count variable is incremented. The pass count variable may be used to keep track of how many iterations through all the possible stations have been performed. In an embodiment herein, the system makes two separate passes over the available frequencies in order to attempt to find an appropriate station, where a different (higher) limit is used for the second pass. However, for other embodiments, any number of passes may be used including a single pass, in which case the pass count variable and associated logic may not be necessary.

Following the step 92 is a test step 94 where it is determined if the pass count variable has exceeded the number of allowable passes. If not, then control transfers from the test step 94 to a step 96 where the predetermined signal strength limit, used at the test step 78 (described above) is adjusted. In an embodiment herein, the signal strength limit is increased at the step 96 in order to increase the likelihood of finding an acceptable station at the next iteration. Of course, if the predetermined signal strength limit is increased to too high a level at the step 96, then the station that is selected may have too much interference (e.g., from commercial radio broadcasts) to be able to provide acceptable performance. Following the step 96, control transfers back to the step 74, described above, to begin the next iteration.

If it is determined at the test step 94 that the pass count variable exceeds the desired number of passes (e.g., two), then control transfers from the test step 94 to a step 98 where the user is provided with an indication (e.g., at the display 52) that no acceptable station was found. For embodiments where the transmitter 24 causes the receiver 26 to automatically adjust to an appropriate frequency, the processing performed at the step 98 may include the transmitter 24 providing an appropriate signal to the receiver 26. Following the step 98, processing is complete.

Note that the processing illustrated by the flow chart 70 performs an automatic search for an acceptable station for the transmitter 26. Unlike a conventional manual search, where the user is required to incrementally tune the receiver 26, “listen” for an acceptable station, and then tune the transmitter, the automatic searching performed by the transmitter 24 automatically determines signal strength at each of a number of potential stations (e.g., by performing appropriate calculations using the received signal).

As described elsewhere herein, in some embodiments, the transmitter 24 may maintain the same station unless and until the user actuates the button 54 or performs some other appropriate steps to affirmatively indicate a desire to change the station. Such changes may become desirable in certain instances. For example, if a user is traveling in an automobile, then a station that is acceptable at a first location may become unacceptable as the user travels to a second location. This may occur, for example, because reception of a commercial wireless signal is stronger at the second location than at the first location.

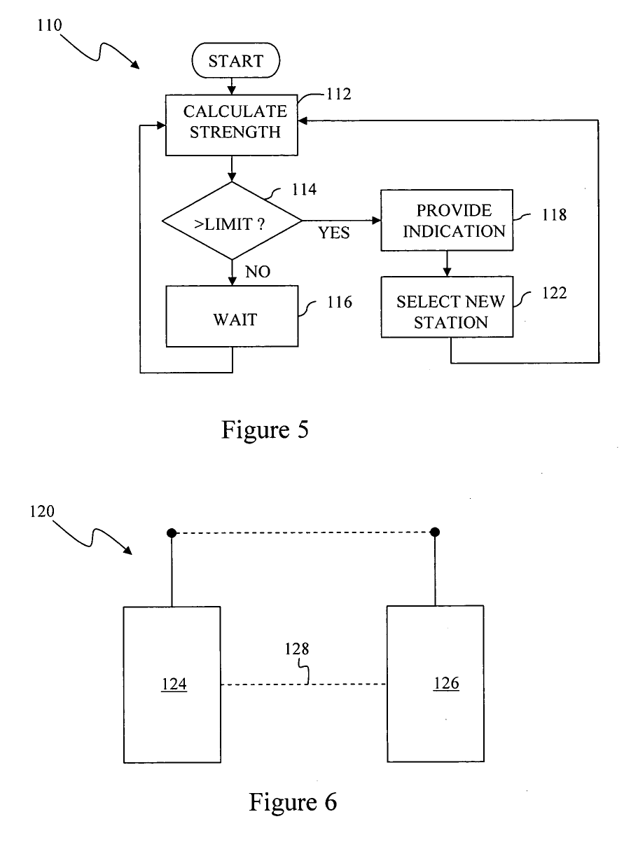

Referring to FIG. 5, a flowchart 110 illustrates steps performed in connection with the transmitter 24 automatically monitoring ambient signal strength to determine if automatic adjustment to a new station is appropriate and, if so, performing that adjustment. Processing begins at a first step 112 where the current ambient signal strength is calculated in a manner like (or identical to) the calculation performed at the step 76 of the flow chart 70 of FIG. 4. In other cases, a signal strength calculation may be performed at the step 112 that is different than the calculation performed at the step 76 of the flow chart 70 of FIG. 4. Following the step 112 is a test step 114 where it is determined if the result of the calculation at the step 112 exceeds the predetermined limit. The predetermined limit used at the step 114 may be the same as the limit used at the step 78 (or used in one of the iterations of the step 78) or may be different. In some embodiments, the limit used at the step 114 to determine if the station needs to be changed may be higher than the limit used at the step 78 to set the station.

If it is determined at the test step 114 that the ambient signal strength is not greater than the limit, then control transfers from the test step 114 to a step 116 where the process waits. The amount of time that the process waits at the step 116 varies according to a desired cycle time of the process illustrated by the flowchart 110. Note that as the wait time is decreased at the step 116, more processing resources of the transmitter 24 may be necessary to continuously or nearly continuously run. However, as the wait time is increased at the step 116, the reaction time for the transmitter 24 to change to a new station may become unacceptably long. Following the step 116, control transfers back to the step 112 to recalculate the ambient signal strength.

If it is determined at the test step 114 that the ambient signal strength is greater than the predetermined limit, then control transfers from the test step 114 to a step 118 where an indication is provided to the user that the current station is unacceptable and the transmitter 24 is automatically selecting a new station. The indication provided to the user at the step 118 may be in any appropriate form including an audio indication (e.g., a beep), an indication on the display 52, or some other indication. Of course, for embodiments where the transmitter 24 causes of the receiver 26 to automatically adjust to a new station, the processing performed at the step 118 may include providing a signal from the transmitter 24 to the receiver 26 indicating that the current station is no longer acceptable. For such embodiments, it may not be necessary to provide any indication to the user. Following the step 118 is a step 122 where a new station is obtained. The processing performed at the step 122 may correspond to the processing illustrated by the flowchart 70 of FIG. 4. Following the step 122, control transfers back to the step 112 for the next iteration.

Note that, in some embodiments, it may be desirable to prevent the transmitter from automatically changing stations too often. This may be provided by increasing the wait time at the step 116, using limits at the step 114 that are higher than the limits used at the step 78 to select a station, or simply by keeping track of the time at which a new station is selected and not allowing station changes for a certain amount of time after the time of the previous change.

Referring to FIG. 6, a diagram 120 illustrates an alternative embodiment where a transmitter 124 automatically causes a receiver 126 to change to the appropriate station without user intervention. There is a connection 128 between the transmitter 124 and the receiver 126 that is different from the wireless signal sent from the transmitter 124 to the receiver 126. In other respects, the transmitter 124 is like the transmitter 24, described above, and the receiver 126 is like the receiver 26, described above. The transmitter 124 is connected to a source device (not shown), like the source device 22 of the diagram 20 of FIG. 1. In the embodiment illustrated by the diagram 120, the transmitter 124 provides a signal to the receiver 126 to cause the receiver to adjust to the station selected by the transmitter 124. In some embodiments, the transmitter 124 may be directly wired to the receiver 126. In other embodiments, the transmitter may use some type of conventional control transmission, such as Bluetooth or WiFi.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

1. A method of transmitting a wireless signal from a transmitter to a receiver, comprising:
receiving an indication that a signal transmission is desired;
in response to the indication, automatically searching an available frequency range for a station meeting an ambient signal strength criteria; and
transmitting the wireless signal to the receiver at the station.

2. A method, according to claim 1, wherein automatically searching the available frequency range includes determining ambient signal strength for each of a plurality of different stations to find a station having an ambient signal strength below a predetermined limit.

3. A method, according to claim 1, wherein receiving an indication includes having a user provide the indication that a new station is to be selected.

4. A method, according to claim 3, wherein the user provides the indication using a button on the transmitter.

5. A method, according to claim 1, further comprising:
providing an indication of a selected station on a display of the transmitter.

6. A method, according to claim 1, further comprising:
providing an indication of a selected station to a receiver.

7. A method, according to claim 6, wherein providing an indication of a selected station to a receiver includes using Bluetooth.

8. A computer readable medium having computer executable instructions for performing the steps recited in claim 1.

9. A method for a transmitter to set a station for transmitting a wireless signal, comprising:
the transmitter selecting a particular station from a number of possible stations for transmission;
the transmitter determining ambient signal strength at the particular station;
in response to the ambient signal strength being below a predetermined first limit, setting the station for transmitting to the particular station; and
in response to the ambient signal strength not being below the predetermined first limit, the transmitter selecting a different particular station from the number of possible stations for transmission and determining ambient signal strength at the different particular station.

10. A method, according to claim 9, further comprising:
the transmitter repeatedly selecting different particular stations from the number of possible stations and comparing ambient signal strength at the different particular stations with the predetermined first limit until either all possible stations have been selected or until at least one of the different particular stations has an ambient signal strength below the predetermined first limit.

11. A method, according to claim 10, wherein selecting different particular stations includes incrementing a station pointer through a range of possible station values.

12. A method, according to claim 10, wherein, in response to there being at least one of the different particular stations having an ambient signal strength below the predetermined first limit, the transmitter provides an indication thereof on a display of the transmitter.

13. A method, according to claim 10, wherein, in response to there being at least one of the different particular stations having an ambient signal strength below the predetermined first limit, the transmitter provides an indication thereof to a receiver.

14. A method, according to claim 13, wherein the transmitter provides an indication to the receiver using Bluetooth.

15. A method, according to claim 10, further comprising:
in response to all possible stations being selected, the transmitter repeatedly reselecting different particular stations from the number of possible stations and comparing determined ambient signal strength at the different particular stations with a predetermined second limit until either all possible stations have been selected or until at least one of the different particular stations has an ambient signal strength below the predetermined second limit.

16. A computer readable medium having computer executable instructions for performing the steps recited in claim 9.

17. A transmitter, comprising:
an first input that receives an electronic audio signal;
a second input that receives ambient signals at a range of frequencies used for transmitting by the transmitter; and
a processor, coupled to at least the second input, that selects a station for the transmitter to transmit the electronic audio signal wherein the processor iteratively tests a plurality of stations in a range of frequencies for the transmitter and selects a station having an ambient signal below a predetermined limit.

18. A transmitter, according to claim 17, further comprising:
a display, coupled to the processor, wherein after the processor selects a station, the processor causes the display to show the station to a user.

19. A transmitter, according to claim 17, further comprising:
a user actuated input, coupled to the processor, for causing the processor to initiate a search for a new station.

20. A transmitter, according to claim 17, further comprising:
transmit and receive components, coupled to the processor and the first input signal, wherein the transmit and receive components cause wireless signals to be sent and received by the transmitter and wherein the transmit and receive components exchange data with the processor to indicate the strength of ambient signals and modulate the first input signal at a frequency selected by the processor.
